(19) United States
(12) Patent Application Publication
(10) Pub. No.: US 2023/0216285 A1
(43) Pub. Date: Jul. 6, 2023

(54) T-Shaped Junction Box

(71) Applicant: Jonathan Winnie, Rolling Meadows, IL (US)

(72) Inventor: Jonathan Winnie, Rolling Meadows, IL (US)

(21) Appl. No.: 17/716,691

(22) Filed: Apr. 8, 2022

Related U.S. Application Data
(60) Provisional application No. 63/295,596, filed on Dec. 31, 2021.

(51) Int. Cl. H02G 3/08

(52) U.S. Cl. CPC H02G 3/085

(57) ABSTRACT

The invention is gap junction box comprising a three-dimensional T-shape, enabling installation in a standard electrical circuit raceway without requiring the bending or moving of conduit lines.

### CROSS REFERENCE TO RELATED APPLICATIONS

This application claims priority to U.S. provisional pat. application 63/295,596, filed on Dec. 31, 2021.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

### Field of the Invention

The invention is a gap junction box for electrical wiring that stands out from a conduit raceway, enabling a user to access all box cutouts.

### Background of the Invention

As long as buildings have comprised electrical power lines, there has been a need to organize electrical wiring and insulate that wiring from inadvertent physical touching, as well from various types of corrosion, such as heat, humidity and liquid water. Over time, electrical conduit construction and installation became regulated under the National Electrical Code (NEC), which is intended to protect people and property from hazards related to electrical wiring, especially fire.

Today, the organization of electrical wiring usually comprises a system of enclosed conduits through which the wires can run, often known as a “raceway” since its appearance is similar to a road system. It is desirable for the conduits to be protective in nature, especially against water, and also to provide a measure of fireproofing should the wires within ignite. Preferred materials for raceway conduits include, but are not limited to, PVC piping or similar nonmetallic materials, galvanized steel or flexible metal conduits (FMC). These materials have different properties and are thus used primarily in specific settings. For example, galvanized steel may the best choice for a highly corrosive atmosphere, while FMCs may be best for a structure that is likely to move or shift. Electrical conduit raceways may be located wherever required, including behind walls, above ceilings or below floors. In utility areas, basements and attics, raceways are more likely to be exposed.

In addition to raceway conduits, junction boxes are also components, usually metal or plastic, within an electrical system where two or more electrical wires are connected. The boxes protect hot (black), neutral (white) and grounding (green or copper) wires as well as other wire colors. As with raceway conduits, the boxes and are intended to protect a building’s electrical connections and allow wires to outflow to other fixture boxes. Currently available junction boxes are brick-shaped and seated within raceways such that, when the box contents need to be checked or serviced, the box must be removed or conduits altered to allow access to the box contents.

What is needed is a junction box that can be seated within an electrical raceway and connected to conduits, allowing access to the box contents without requiring removal or rearrangement of the conduits’ pathways.

### BRIEF SUMMARY

In a preferred embodiment, a gap junction box comprising a three-dimensional T-shape with an open top side, comprising a plurality of knockout holes, mounting holes and a ground wire attachment.

In another preferred embodiment, the gap junction box as described herein, wherein the plurality of knockout holes are embodied as circles in one or more diameters to accommodate standard electrical wire conduits.

In another preferred embodiment, the gap junction box as described herein, wherein the plurality of knockout holes each have a diameter between 0.5” and 0.75”.

In another preferred embodiment, the gap junction box as described herein, wherein the plurality of knockout holes each have a diameter between 0.75” and 1.25”.

In another preferred embodiment, a method of using the gap junction box as described herein, comprising the steps of: (a) fitting one or more knockout holes over one or more corresponding base conduits of an electrical conduit raceway such that the portions of the box containing additional knockout holes are raised above the raceway conduits, (b) attaching a first end of a ground wire to the ground wire attachment; and (c) accessing one or more of such additional knockout holes without bending or otherwise adjusting the box or the base conduit lines.

In another preferred embodiment, the method as described herein, wherein the gap junction box is mounted via its mounting holes on a Unistrut, ceiling or wall.

### BRIEF DESCRIPTION OF THE DRAWINGS

FIG. 1 is a line drawing evidencing a top perspective view of the inventive T-shaped junction box.

FIG. 2 is a line drawing evidencing a bottom perspective view of the junction box of FIG. 1.

FIG. 3 is a line drawing evidencing an end view of the junction box of FIG. 1.

FIG. 4 is a line drawing evidencing a side view of the junction box of FIG. 1.

FIG. 5 is a line drawing evidencing the junction box of FIG. 1, installed into an electrical conduit racetrack.

### DETAILED DESCRIPTION OF THE INVENTION

The invention constitutes a gap junction box for electrical connections, designed with a “T-shape” enabling the installer/user to fit the box within a standard raceway of electrical conduits in a ceiling or wall, such that the box will stick out from the conduit lines. As a result, a user will be able to access all knockout holes without having to bend or otherwise move the conduit lines.

By obviating the need to rearrange conduit lines, the inventive design will save time and labor costs for any property owner needing to install or access a junction box as part of an electrical wiring project, or any such person hiring and paying an electrician for such services.

### Detailed Description of the Drawings

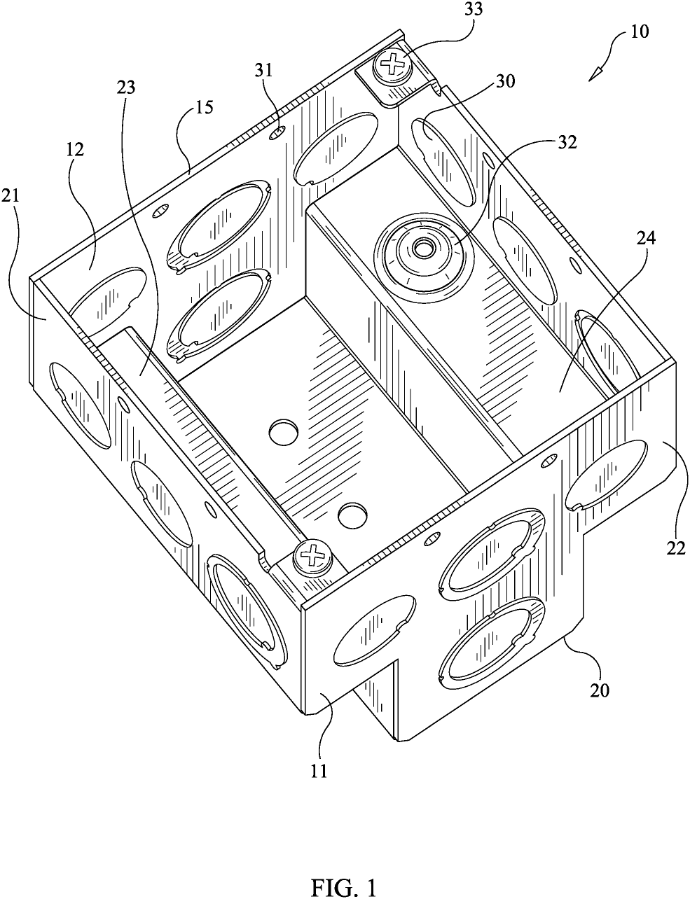

FIG. 1 is a perspective view of the inventive T-shaped junction box 10, looking down into the open top of the box and showing the inner surface 12. The T-shape itself is comprised of a first wing 21 with a first shelf 23, a second wing 22 with a second shelf 24, each wing connected to a center post 20. The junction box is oriented such that the two ends 13 show the T-shape, while each of the two sides 14 include the sides of a wing and the center post.

Each of the sides and ends comprises a plurality of knockout holes 30, embodied as approximately circular areas that have been partially cut from the body of the box such that they may be pushed out with a tool or a user’s thumb to enable electrical lines to enter and exit the box. In a preferred embodiment, based on the size of the junction box and whether it is residential or commercial in purpose, each knockout hole is between 0.1” and 1.5” in diameter. In a more preferred embodiment, for residential use, each knockout hole is 0.25” to 0.75” and for commercial use, each hole can be between 1” and 1.25”. Knockout holes may optionally be left unopened if not needed. As drawn, each side comprises three knockout holes along the wing and each end comprises four knockout holes. In practice, the box may include as many knockout holes as practicable and as few as desired.

In addition, the body of the box comprises a plurality of mounting holes 31, sized to accommodate a mounting screw or bolt for attachment of the box to a ceiling, beam, or other point of attachment within a raceway. Cover screws 33 are also evident at the corners of the open top 15 for optional attachment of a flat cover piece (not pictured). In practice, the mounting holes would be sized for mounting screws 0.25” to 0.5” in diameter, although commercial application sizing may allow for even larger mounting screws.

Also pictured is the convex side of a ground wire attachment 32 on the second shelf, which is open to accommodate a ground wire screw (not pictured) when in use to down a ground wire, also known as a grounding pigtail wire (not pictured).

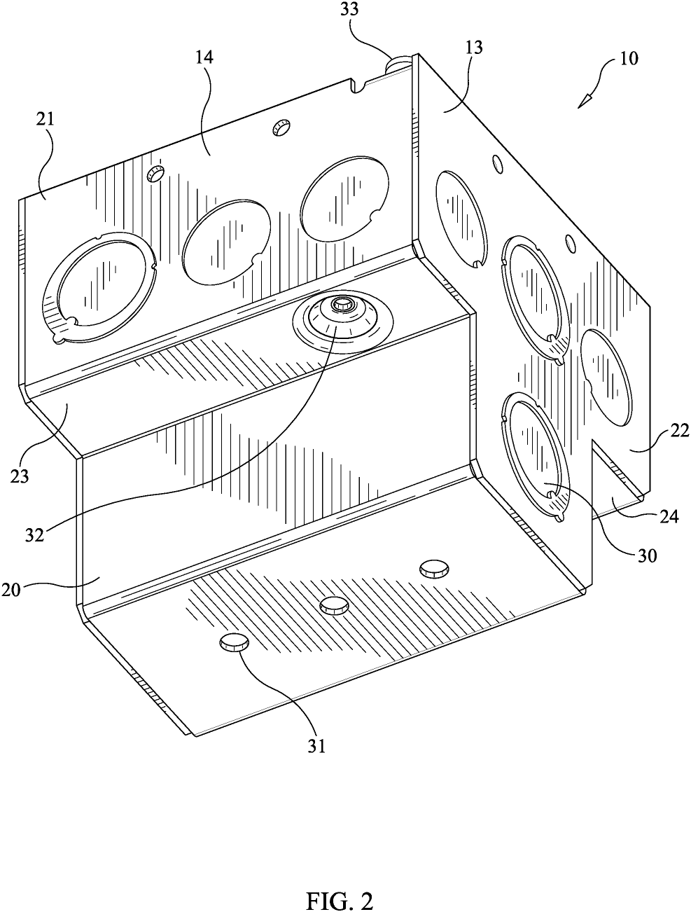

FIG. 2 is an alternate view from below of the box of FIG. 1, evidencing the same parts. In this view, first wing 21 extends forward, showing the concave side of a ground wire attachment 32 located in first shelf 23. Again, a plurality of knockout holes 30 and mounting holes 31 are visible.

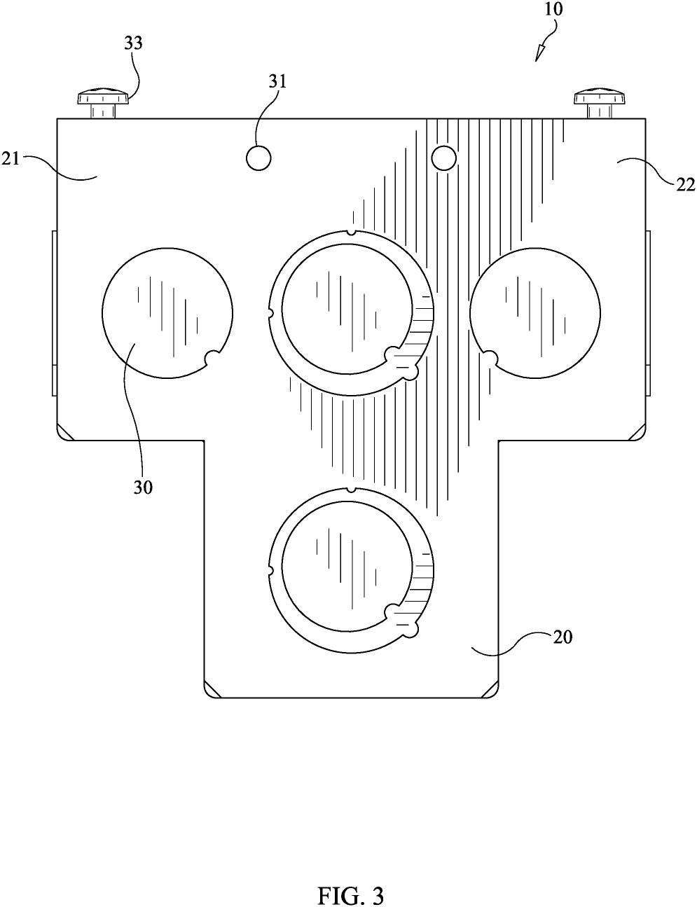

FIG. 3 is an end view of the junction box of FIG. 1, showing the T shape of the box with first wing 21 to the left, second wing 22 to the right and center post 20 at the bottom. Four knockout holes 30 and two mounting holes 31 are visible as are the two cover screws 33.

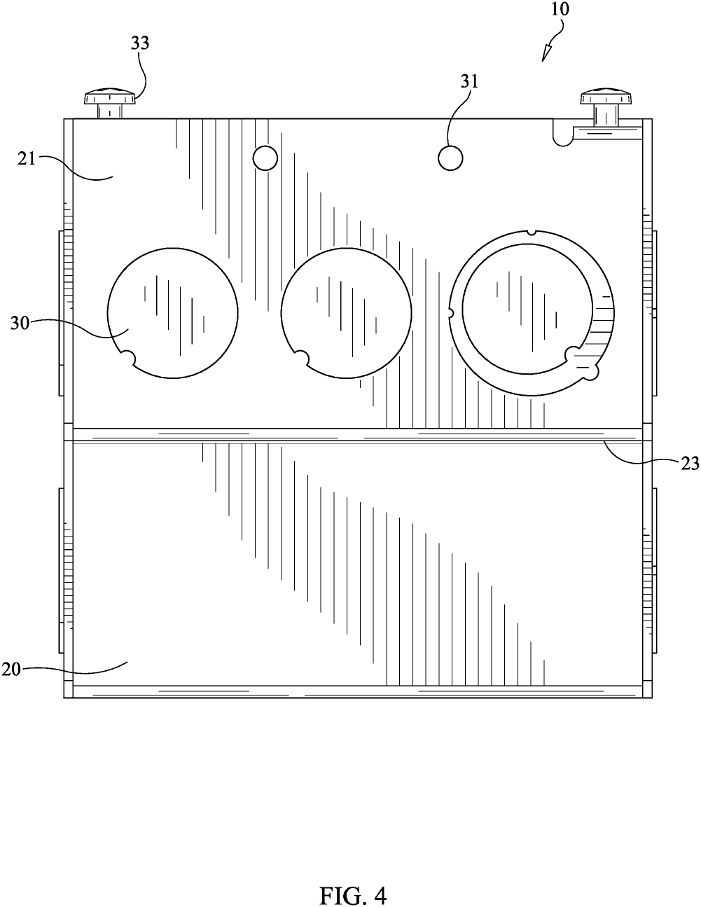

FIG. 4 is a side view of t FIG. 3 is a line drawing evidencing an end view of the junction box of FIG. 1.

FIG. 4 is a line drawing evidencing a side view of the junction box of FIG. 1.

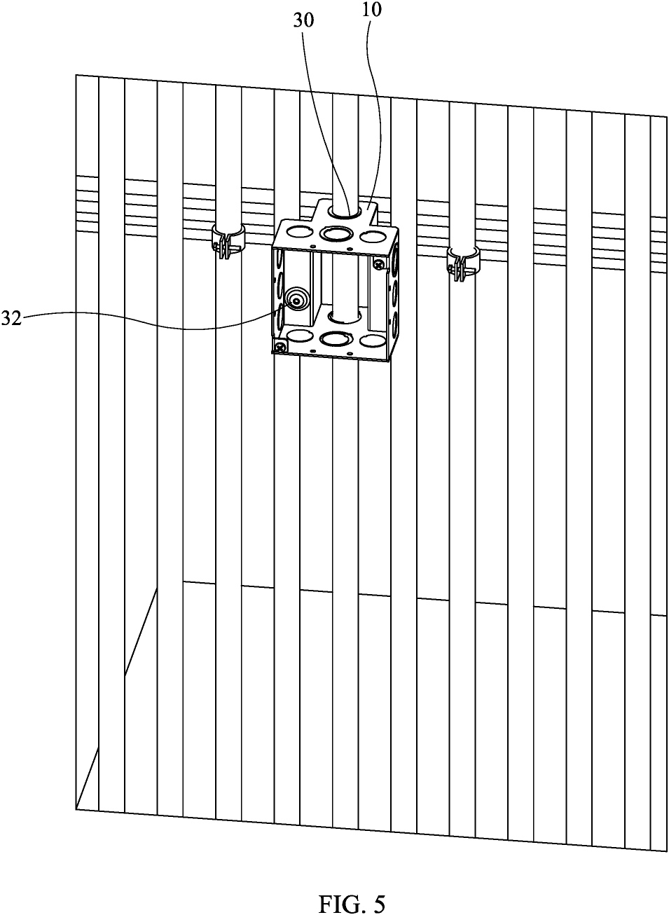

FIG. 5 is a line drawing evidencing the junction box of FIG. 1, installed into an electrical conduit racetrack.

The junction box of FIG. 1 showing first wing 21 over center post 20, separated by first shelf 23 Again, knockout holes 30, mounting holes 31 and cover screws 33 are visible.

FIG. 5 is a line drawing evidencing the junction box of FIG. 1, installed into an electrical conduit racetrack, with at least one conduit inserted into a pair of knockout holes 30, with the first shelf and second shelf emanating below the conduits and evidencing the ground wire attachment 32.

Invention components

| | |
|---|---|
| 10 | Junction box |
| 11 | Outer surface |
| 12 | Inner surface |
| 13 | End |
| 14 | Side |
| 15 | Open top |
| 20 | Center Post |
| 21 | First wing |
| 22 | Second wing |
| 23 | First shelf |
| 24 | Second shelf |
| 30 | Knockout holes |
| 31 | Mounting holes |
| 32 | Ground wire attachment |
| 33 | Cover screws |

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable equivalents.

We claim:

1. A gap junction box comprising a three-dimensional T-shape with an open top side, comprising a plurality of knockout holes, mounting holes and a ground wire attachment.

2. The gap junction box of claim 1, wherein the plurality of knockout holes are embodied as circles in one or more diameters to accommodate standard electrical wire conduits.

3. The gap junction box of claim 1, wherein the plurality of knockout holes each have a diameter between 0.5” and 0.75”.

4. The gap junction box of claim 1, wherein the plurality of knockout holes each have a diameter between 0.75” and 1.25”.

5. A method of using the gap junction box of claim 1, comprising the steps of:
1. fitting one or more knockout holes over one or more corresponding base conduits of an electrical conduit raceway such that the portions of the box containing additional knockout holes are raised above the raceway conduits,
2. attaching a first end of a ground wire to the ground wire attachment; and
3. accessing one or more of such additional knockout holes without bending or otherwise adjusting the box or the base conduit lines.

6. The method of claim 5, wherein the gap junction box is mounted via its mounting holes on a Unistrut, ceiling or wall.
